(19) United States
(12) Patent Application Publication
(10) Pub. No.: US 2006/0136451 A1
(43) Pub. Date: Jun. 22, 2006

(54) Methods and systems for applying attention strength, activation scores and co-occurrence statistics in information management

(76) Inventor: Mikhail Denissov, Mississauga (CA)

Correspondence Address: Stephen B. Salai, Esq.;Harter, Secrest & Emery LLP, 1600 Bausch & Lomb Place, Rochester, NY, 14604-2711, US

(21) Appl. No.: 11/047,819

(22) Filed: Feb. 1, 2005

Related U.S. Application Data
(63) Continuation-in-part of application No. 11/021,125, filed on Dec. 22, 2004.

(51) Int. Cl. G06F 17/00

(52) U.S. Cl. 707/101

(57) ABSTRACT

Methods and systems for applying attention strength, activation scores and co-occurrence statistics to information management. Attention strength values used in computing the base activation scores of information items are derived from user interactions with such items. Co-occurrence strength values used in computing associative activation and partial matching scores of information items are also derived from attention strength values. Activation scores of information items are then derived and employed in a variety of information management methods and systems.

### CROSS-REFERENCE TO RELATED APPLICATIONS

This application is a Continuation-In-Part of U.S. application Ser. No. 11 /021,125 filed Dec. 22, 2004, which prior application is hereby incorporated by reference herein.

### FIELD OF THE INVENTION

The present invention generally relates to the field of applying cognitive sciences, in general and activation theory, specifically, to information management, i.e., to methods and systems for applying attention strength, activation scores and co-occurrence statistics to information management.

### BACKGROUND OF THE INVENTION

As the sources and number of information items continue to grow exponentially due to advancements in computer technology and networking, including the Internet, effective management of information is becoming a higher priority not just for information workers, but for average consumers and users of information as well.

For example, a key aspect of information management lies within the ability to score and hence rank the relevance of retrieved information items.

Conventional information retrieval systems, including web-based and stand-alone search engines, usually employ one of two main methods to score and rank information items to match a retrieval query. The first approach is a probabilistic determination based on the number of historical citations or references by other information items. The Google Search Engine and other engines employing link analysis use this approach. The second approach involves matching the text searched based on indexed terms and the number of occurrences of such terms within a document. The Microsoft indexing services and other local desktop or Internet search engines use this approach.

Neither of these mechanisms includes a user-specific context as a factor in scoring and ranking the relevance of retrieved information.

Other prior art tries to include user interest as a retrieval specification as well as a scoring/ranking factor, by using one or more of the following means:
a) Guiding users in pre-configuring user profiles, such as geographical, education, gender, personality traits, interests, and other user-specific data to affect the scoring/ranking of the set of retrieved information items;
b) Soliciting relevance factors from users before launching a retrieval query and applying these factors as weighted attributes to score/rank the retrieval results;
c) Aggregating the popularity of information items based on historical patterns and information about the current context of interest (as opposed to a user-specific context); and/or
d) Monitoring the user's response to the presented initial search results, and going through one or more subsequent iterations to refine the retrieval and scoring/ranking of information items.

The aforementioned techniques may not be optimal for many situations. For example, in some situations it may be desirable to rank information items based on their general past usefulness derived from the frequency, duration and recency of prior use, either independent of, or in addition to, the ranking that could be given to the information items using additional criteria for the purpose of achieving certain objectives. The present invention provides this capability absent in the aforementioned prior art. Similarly, none of the aforementioned techniques implicitly develops a user-specific context for both old and new information items based solely on the past use of information items by users. The present invention also overcomes this deficiency. The significance of the invention can best be understood with reference to the application of the formula used to measure activation of an information chunk in the ACT-R model to information retrieval. That formula is:

$${A}_{i} + {B}_{i} + {\sum }_{j} {W}_{j} * {S}_{ji} + {\sum }_{k} {MP}_{k} * {Sim}_{kl} + N ( 0 , s ) \qquad [ 1 ]$$

where,
Bᵢ represents the base activation of an information item,

$${\sum }_{j} {W}_{j} * {S}_{ji}$$

represents the associative activation between information items

$${\sum }_{k} {MP}_{k} * {Sim}_{kl}$$

represents the partial matching of information items towards a goal, and N(0,s) represents a noise factor

The most important measurement is base activation which, for the purpose of the invention, represents the general past usefulness of an information item, and is one of the main areas of focus of the present invention. The associative activation represents similarity in the concepts associated with information items, and is also a significant area of the focus of the invention. Furthermore, the present invention also measures the partial matching of context represented by information items by analyzing co-occurrence statistics of information items within an information space.

In prior art which measures relevance of information items only through interpreting the contents of said items, the partial matching term in the above formula in the context of information retrieval is the keyword matching used by indexed term search engines. Without the measurement of base activation and associative activation, the ranking of the relevance of retrieved information items relative to the search term is based solely on keyword matching. By also applying base activation, associative activation and partial matching scores of context (the latter two types of scores flowing directly from the co-occurrence statistics of information items) in the ranking of information items, a much higher degree of relevance in the ranking of the retrieved results can be achieved relative to the retrieval specification or objective.

The prior art employs link analysis, e.g., user interaction patterns involving retrieved information items, or number of citations from other information items, to simulate associative activation between information items for the purpose of ranking such items. Therefore, such methods confine the measurement and usefulness of associative activation to the contexts associated with the specific purposes for which users previously retrieved information items. By contrast, the invention emulates associative activation as applied to the human memorization process, where often the context may not be clearly articulated.

While the preceding discussion relates to information retrieval, the application of the invention is equally useful in other information management contexts as well. First, the co-occurrences between two information items provides a mechanism to measure associative strength/activation of the said items. Second, the co-occurrence statistics are basically encoded contextual cues of information items, which provides a mechanism to determine partial matching measurements of their context. This approach of measuring co-occurrence statistics of information items thereby provides a non-deterministic context for the measurement of associative activation for any given information space that is not limited by the past purposes for which the information items were previously retrieved. However, at the same time, the associative activation scores assigned to information items will also reflect the context they represent.

### SUMMARY OF THE INVENTION

It is an object of the present invention to provide methods and systems for applying attention strength, activation scores and co-occurrence statistics to information management. Therefore, it is one object of the invention to measure attention strength values used in computing the base activation scores of information items from user interactions with such items.

According to one aspect of the invention, it provides a method for measuring the attention strength directed by a user towards one of one or more information items present in a presentation channel during an interaction period of time in which the user directs attention towards a target information item through one or more proactive or passive interactions with the target information item, the method comprising, recording the start time of the interaction period as represented by the start of an event through which the user directs attention towards the target information item, recording the end time of the interaction period as represented either by, the passage of a specified period of time during which the user does not direct any attention towards the target information item, or the start of another event that confirms that the user is not directing any attention towards the target information item, measuring the duration of the interaction period as the difference between the end time and the start time of the interaction period, dividing the duration of the interaction period into attention units appropriate to the presentation channel, counting the number of attention units within the interaction period during which the user directed attention towards the information item proactively (hereinafter called the proactive attention period), counting the number of attention units within the interaction period during which the user directed attention towards the information passively (hereinafter called the passive attention period), allocating the attention units in the proactive attention period to the target information item, and allocating the attention units in the passive attention period among the target information item and all of the rest of the information items present in the presentation channel, based on the presentation characteristics of each of the information items in the presentation channel.

It is another object of the invention to measure co-occurrence strength values used in computing associative activation and partial matching scores of information items from attention strength values.

According to a second aspect of the invention, it provides a method for measuring co-occurrence strength values of pairs of information items in an information space.

It is another object of the invention to rank information items retrieved in response to a search query according to various criteria that include activation scores.

According to a third aspect of the invention, it provides a method for ranking retrieved information items and a system for retrieving and ranking information items in response to a search query according to criteria that include one or more of base activation, associative activation, or partial matching scores, together with any other search criteria that may be specified.

It is a further object of the invention to employ information item activation scores in other information management contexts.

### BRIEF DESCRIPTION OF THE DRAWINGS

The invention will now be described in more detail with reference to the accompanying drawings, in which:

FIG. 1 illustrates the decay in base activation of an information item over time and the accumulation of base activation;

FIG. 2 illustrates partial base activation processing based on the presentation strength of presented information items within a presentation channel;

FIG. 3 illustrates how a user-specific context represented by information items having high activation scores could form part of subsequent search specifications to retrieve relevant information;

FIG. 4 illustrates how the present invention provides a means to measure the similarity of probability distributions of occurrences of information items within an information space;

FIG. 5 illustrates the use of co-occurrence probabilities in ranking information items within a time domain context; and

FIG. 6 illustrates how co-occurrence statistics within a time context can be used in information retrieval.

FIG. 7 illustrates the use of co-occurrence probabilities in measuring the associative strength of information items within a context other than time.

FIG. 8 illustrates an information search system that applies the present invention.

FIG. 9 illustrates how co-occurrence statistics can be used in the pursuit of specific retrieval goals.

FIG. 10 illustrates the application of the present invention in an enterprise knowledge base.

FIG. 11 illustrates the application of the present invention in presentation.

FIG. 12 illustrates the application of the present invention in data synchronization.

### DESCRIPTION OF PREFERRED EMBODIMENTS

The present invention generally relates to methods and systems for applying attention strength, activation scores and co-occurrence statistics to information management.

Throughout this document, each of the following terms has the corresponding meaning ascribed to it below as follows:

“information item” means a collection of information organized and presentable as a unit and includes, without limitation, a document, web page, email item, calendar item, document properties, and other item that is presentable as a collection of information. For the purpose of this invention “information item” is used instead of the term “information chunk” originally employed in activation theory;

“item” is used interchangeably with “information item” throughout the document.

“document” is one example of an information item, but the two terms are often used interchangeably herein for purpose of illustration;

“user” includes any user capable of consuming information items, including, without limitation, a human user and a non-human user, such as but not limited to a software agent;

“consumption”, “deployment”, “use”, “recall”, “reuse”, and “open” are used interchangeably to indicate the use of an information item in its presented and interacting form and “close” refers to the cessation of all such activities;

“practice” is drawn from the context of activation theory within cognitive science, and means making an effort to remember a step or sequence of steps related to the attainment of a goal (i.e., a purpose or result);

“ACT-R” is a theory and related cognitive architecture for simulating and understanding human cognition, with a focus on how human knowledge is acquired and deployed;

“activation” is drawn from the field of activation theory and reflects the degree to which past experience and current context indicate that an information chunk will be useful at any particular moment. In this context, an information chunk comprises a structure representing declarative knowledge, which is knowledge of which humans are aware and can describe to others. Usefulness of an information chunk at a particular moment is measured in terms of the usefulness towards the attainment of a production goal (i.e., whether the chunk is useful or can be employed for a particular purpose or to achieve a particular result). In the context of this invention, activation and ACT-R theory are applied broadly to information items in the context of any collection of information items (i.e., information space), rather than being applied to modeling information structures and recall in the human brain, (which is the original purpose of ACT-R theory);

“base level activation” or “base activation” is activation determined solely by the frequency, duration and recency of use of an information item, thereby quantifying the general past usefulness of the information item and providing a general context-independent estimation of how likely the information item is to be useful;

“base activation of an interaction” means an instance of practice of an information item, and includes, without limitation, both base activation arising from the presentation of the item and/or from actual user interaction with the item;

“associative activation” in activation theory is a measure of how often two information chunks are retrieved (i.e., thought of) concurrently, and for the purpose of the invention, this translates into how often two information items are used concurrently;

“presentation channel” includes any channel by which an information item can be presented for consumption by a user, and includes, but is not limited to, any visual, audio and/or any other sensing channel;

“presentation strength” means measurement of implicit user activities when an information item is presented to the user, based on the characteristics of: (i) the presentation; (ii) the presentation channel; and (iii) the item;

“events” within a presentation channel includes without limitation, all detectable user activities with the presented information items, as well as any change in the presentation characteristics of the said items;

“user activity strength” or “strength of user activity” means measurement of explicit user activities directed towards an information item through observed events, with or without the use of monitoring apparatus or input devices, or other equipment;

“an interaction” or “interaction period” of a user with an information item constitutes the period measured from when attention to the item is first detected to the time no more attention is detected (which period can be increased by any applicable attention inertia lead time when attention is directed towards an item before it is detected, and can be increased by any applicable attention inertia lag time when attention continues to be directed towards an item immediately after such attention is no longer detected), and such a total interaction period can include a group of events localized in time, and “interact” and “interacts” in this context have corresponding meanings; and

“co-occurrence” of two or more information items simply means the appearance of those items within a same context, which may or may not represent a goal.

The present invention, which relates to new information management methods and systems, is derived from the following principles: (1) the relevance of an information item to a user not only depends on the content it carries, it also depends upon how often and how well it is consumed by the user; (2) retaining useful information items is as important as acquiring new information items; (3) the co-occurrence statistics of two information items within an available information space yields information concerning the associative strength among the said items; (4) over time a user's acquisition of information items helps to define a general information context for the user; and (5) co-occurrence statistics of information items implicitly provide information with respect to the similarity in context of the information items.

This application of activation theory to information management is novel and has a number of advantages over the prior art.

First, an information access system implementing the present invention can be treated as an extension of human memory and the ranking of information items can be improved in terms of relevance and usefulness to users by basing it on frequency, duration and recency of use, which are context-independent, in addition to, or instead of, other context-dependent factors.

Second, this technique implicitly develops a user-specific context for both old and new information items based solely on the past use of information items by users.

Third, the invention enables the measurement of associative activation of information items, and the partial matching of context of such items based on the observed co-occurrence of such items within an information space, thereby providing information on the similarity of context of information items.

Finally, the invention also enables multiple users to contribute dynamically to the ranking of information items employed by the users, thereby creating an institutional “memory” of the relative usefulness of the items to the users as a whole.

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments illustrated but is to be accorded the widest scope consistent with the principles and features described herein.

The present invention applies the modeling of human learning and memory practices (i.e., remembering, and forgetting) to information items presented to one or more users in order to improve the relevance of the scoring and ranking of the information items to the user(s). More specifically, the present invention relates the amount of attention received by an information item within one or more presentation channels to a set of practices or memorization steps taken to remember the said information item. The invention is premised on the concept that an information access system containing information items whose base level activation has been measured is virtually an extended memory of a user of the information items. Thus, the more frequent, recent, and well-practiced the information items are, the greater the likelihood that the said information items will be recalled.

A simplified process of human memorization and retrieval can be represented by following stages:
Attention→Encoding→Storage→Retrieval

The encoding, storage, and retrieval processes are complex hidden functions internal to the brain and are difficult to quantify, however, user attention to particular information items can be directly measured through attention tracking devices, or indirectly measured through the observation of the presentation of such items in one or more presentation channel(s), as well as user activities focusing on the said item.

When an available information item is presented to a user for an amount of time, the attention directed towards the said item can be measured and recorded, and a corresponding base activation score can be computed. It is well-known within activation theory that such activation measurements can incorporate decay due to time elapsed and/or interfering events and noise factors to simulate the effects of the human memory processes of forgetting and information overload.

The measurement of base activation of an information chunk within activation theory is based solely on frequency and recency of use of the chunk, since the purpose of the retrieval of the chunk is known, and the full attention of the user towards the information chunk can be assumed. However, within an information presentation channel, the goal of all the presented information items are not necessarily similar, and so each presented item is considered to be competing for attention; hence a method to measure the amount of attention received by each presented item is essential. The present invention measures the base activation of presented information items, by observing the attention each information item receives. This is done by detecting when full user attention is directed towards an information item, by detecting distributed attention to concurrently presented information items based on their presentation characteristics when no user attention focused towards any particular item can be detected, and by detecting the absence of any user attention.

The following is a detailed description of the attention strength measurement of information items in a preferred embodiment. The frequency and recency of use of an information item is tracked via mechanisms that track time, while the degree of practice of the item is measured via presentation of, and user interactions with, the said item. The present invention measures how well an information item is practiced by observing how much attention each presented item has received. The base activation of an information item at any point in time is derived from the accumulated attention given to the item and the decay in the previously measured base activation over time.

The attention of a user towards presented information items are serialized events across time. In other words, when two documents are concurrently presented, the user can only focus on one specific document at a specific time. Therefore the measurement of attention is achieved by monitoring the occurrences of events that provide an indication of attention (or absence of attention) and the time lag between such events. Examples of such attention-related events include, without limitation, detectable events such as the change in size of information items, rates of change of information items, user inputs via input devices, activation of screen savers, etc. The lag times are small time gaps between events that can be regarded as part of the continuum of the occurred events, such as the lag time between keystrokes in a keyboard input process. When the time between events is greater than a pre-selected lag threshold, a time gap between events is said to have occurred. The occurrence of such attention-related events can be modeled, for either typical humans or specific users, using a probability density function, with the function chosen depending on the characteristics of presentation within a particular presentation channel, as well as the methods of user interactions with the channel.

For example, in a preferred embodiment employing a visual presentation channel, the attention-related events are considered to have equal weights, and so a probability density function with a lognormal distribution would be chosen. However, in a system featuring events that differ from each other in the degree to which they can draw attention, the events are not equally weighted and two or more lognormal distributions, or other probability density functions may be employed. In either case, when the probability density of events drops below a certain threshold, it can be assumed that user is no longer paying attention.

In a preferred embodiment of the present invention, the base activation of presented information items is updated whenever new attention-related events occur. The time elapsed since the previous event occurred contains a number of evenly spaced time slots, hereinafter called attention units. In a visual presentation channel without external attention-tracking devices, the attention unit is the eye-fixation time in biological band, ranging from 200-400 milliseconds, which models the amount of time that it takes a human to fix an eye on an information item depending on the complexity of the presented item and the characteristics of the user. The determination of the duration of attention units can be further calibrated through software applications. When eye-tracking devices are available, the eye fixation and saccades statistics will provide more precise measurement of attention units. The number of attention units received by an information item within the period of consumption represents its strength of activation during the consumption.

When the base activation of the presented information items is updated, the attention units are distributed to the presented information items according to their occupancy percentage of space within the presentation channel(s). However, this distribution does not always correspond to the perceived occupancy of the items within the presentation channel. For example, if an item has the full attention of a user (which can be assumed from some form of user interaction with the item), the said item will logically occupy 100% of the presentation space as far as the user is concerned and so the number of attention units allocated to the item will reflect that. In the scenario when no user activities are detected, the presentation characteristics of the items will depend on their characteristics within the presentation channel. In a visual channel, such characteristics could include for example, relative size and color contrast, animation, and distance of items from the previous item that enjoyed full user attention, to name a few, and such characteristics will all contribute to the number of attention units allocated to each item. Finally, as stated above, when the absence of attention-related activities is detected based on pre-defined thresholds, the absence of attention is assumed.

It should be noted that the same principles can be applied to other presentation channels. For example, in an audio channel, attention units could be represented by the smallest note length perceptible by humans, i.e., approximately1/128, or one or more multiples of the said note length whenever applicable, whereas presentation characteristics can be related to audio signal volumes, frequencies, loudness (perceived volume), pitch (perceived frequency) and other psychoacoustic parameters of such signals.

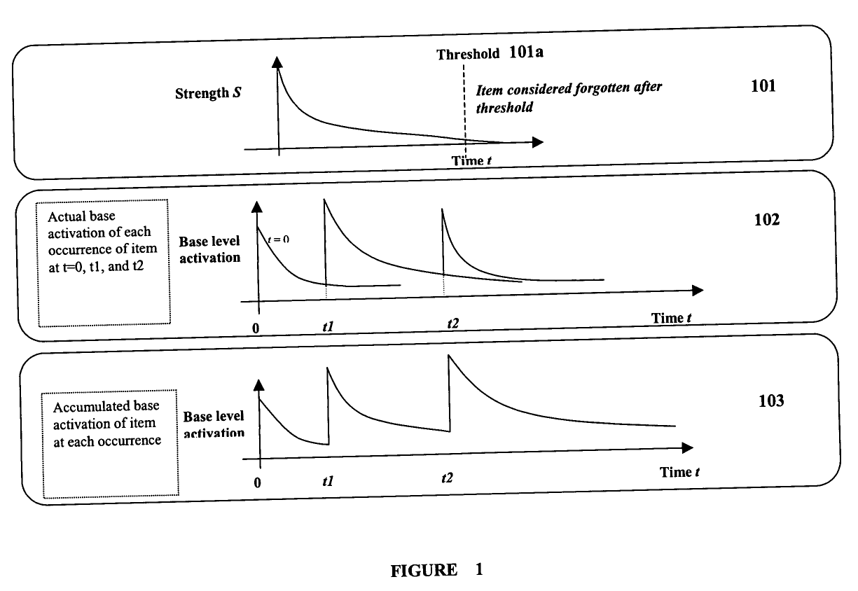

FIG. 1 shows an example of an instance of measured base level activation of an information item 101. The strength of activation is measured via the sum of the applicable strength units, denoted by the variable Sand represents how well the information item is practiced within said instance. S varies as a function of time, represented by the variable t. S has a maximum value at the point of measurement t=0 and decays over time. Note that when time passes a certain threshold 101a, the value of S is so low that the item is considered forgotten. The graph in the middle 102 demonstrates how base activation is measured individually from each interaction. The bottom graph 103 demonstrates how each base activation measurement is accumulated.

The decay in human memory can be modeled mathematically by decreasing negatively accelerating functions such as power and exponential functions. The present invention employs the power function originated in the power law of forgetting and deployed in ACT-R adapted to the information management context of the present invention to measure the base activation of an information item/over time in an information context. That formula is:

$${B}_{i} = ln {\sum }_{j = 1}^{n} {S}_{ij} {t}_{j}^{- d} \qquad [ 2 ]$$

where,
Bᵢ is the attention or base activation of information item i gained through presentation or user activities,
Sᵢⱼ is the strength information item i at its j^{th} occurrence based on presentation characteristics or user activities,
tⱼ is the time lapsed since the j^{th} occurrence of information item i,
d is the decay parameter that simulates the process of “forgetting” in the context of information items, and
n is the number of times the information i has occurred.

Note that the strength Sᵢⱼ varies at each instant in time according to presentation characteristics or types of user activities, and is represented by the number of aforementioned attention units allocated to each information item.

When attention tracking and attention/decay emulation devices are present, the cumulative attention (i.e., attention units) directed towards an information item can be precisely measured since the attention strength and decay associated with individual attention units can be accurately tracked and allocated to information items. However, in a preferred embodiment without the aforementioned devices, the attention of each interaction period is measured as groups of attention units being distributed among presented items. The said interaction period begins with a noticeable event signifying the beginning of attention (such as opening an item or resuming attention), to another noticeable events signifying the end of attention (such as closing an item or absence of attention detected).

The present invention distributes attention units to concurrently presented information items based on the detection of user activities and presentation characteristics of the said items. For example, if any targeted user activities towards an information item such as inputs are detected, the information item is said to have the undivided attention of user and the strength (S) is equal to sum of all attention units within the period of interaction. In other words, the rest of the concurrently presented information items will receive zero attention and hence will not receive any allocation of attention units. In the absence of user activities, attention units will be allocated to presented information items using probability-based statistical techniques for predicting user eye-fixation, or other such perceptual cues as measures of attention. In a preferred embodiment, the present invention assumes that user attention to each presented information item is proportional to the space occupied by the item within the presentation channel, hereinafter referred as occupancy percentage. However, as aforementioned, the occupancy percentage does not relate only to physical dimensions, but also depends on the presentation characteristics of the said item, including without limitation, any event such as rate of change of presentation, presence or addition of sound, static and dynamic graphical elements, the amount of time elapsed since the previous focused user activity, the distance from the identified information item of most recent focus, etc. In other words, the occupancy percentage of an information item is directly proportional to the ability of the item to draw attention. Various other modeling techniques can be used by those skilled in the art to take such additional complexity into account. When the total number of presented items competing for attention in the same presentation channel(s) exceeds a threshold, the items with relatively less ability to draw attentions may not receive any attention units, simulating information overloading. In this regard it should be noted that research has shown that typical humans can only pay attention to no more than five to seven items concurrently, so when more than seven information items are presented concurrently, the items with occupancy percentages less than the 7th lowest item will not receive any attention. In the discussion that ensues, the strength of practice obtained from user input is called “user activity strength”, and the strength of practice obtained from presentation is termed “presentation strength”.

It should be noted that base activation is cumulative. In other words, a measurement of base activation at any instant in time according to the formula will take into account the residual activation and decay associated with previous interactions, whether those previous interactions result from user interactions with the information item or from presentation of the item.

The measurement of presentation strength and user activity strength are now described in further detail.

Presentation strength can be measured through various attributes of the information item(s) being presented to a user within the presentation channel. For example, in a preferred embodiment of the invention involving a computer system that incorporates a visual display (e.g., monitor) as a presentation channel, the presentation format of documents displayed on the monitor can be minimized, maximized, represented pictorially or textually, the font sizes of the documents or the amount of real estate within the presentation channel occupied by each document can vary, etc. These and other possible variations in the format of a document displayed on the monitor affects the base activation of the said items.

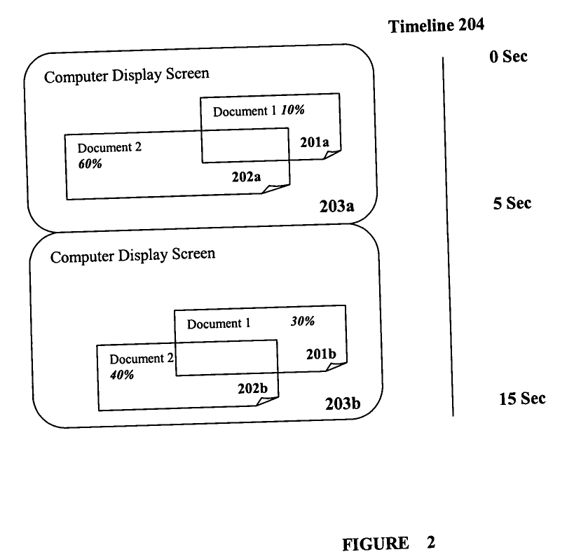

FIG. 2 provides an example in which the presentation strength of each of two information items (i.e., documents) 201a/201b and 202a/202b is related to the amount of real estate occupied by each of the information items 201a/201b and 202a/202b within the (visual display) presentation channel comprising a computer display screen 203a/203b over a specified period of time. For illustration purpose, other presentation characteristics of the two said items are not considered. At the start of the presentation interval, when the time=0 seconds on a presentation channel display timeline 204, documents 1 201a and 2 202a are first presented on the display screen 203a. At this time, document 1 201 a occupies 10% of the display screen 203a, while document 2 202a occupies 60% of the display screen 203a. When the time=5 seconds on the presentation timeline 204, the user adjusts the focus and resizes the documents 201a/201b and 202a/202b so that document 1 201 b now occupies 30% and document 2 202b occupies 40% of the display screen 203b. At time=15 seconds on the presentation timeline 204 the documents 201b and 202b are closed by removing them from the presentation channel 203b. Assuming (for illustrative purposes) that equal weights are given to documents in focus and out of focus, the number of attention units allocated to each document 201a/201b and 202a/202b, using 200 millisecond as the attention unit, can be calculated based on the amount of real estate occupied on the monitor by each document and the duration of such occupation as follows:
Document 1: (5 sec*0.1+10 sec*0.3)/0.2 sec=17.5
Document 2: (5 sec*0.6+10 sec*0.4)/0.2 sec=35.0

The number of concurrently displayed documents and their attributes also affects the partial measurement of base activation resulting from their presentation, just as information overload affects memorization by humans.

The measurement of user activity strength of an information item is based upon the detection of user-active events such that said item gains the undivided attention of the user. For example, when interaction tasks associated with a computer system, such as keyboard input, mouse actions to highlight, cut and paste, or other interactions from devices such as digital pens, game controllers, etc. are performed on a presented information item, the said item can be said to have the undivided attention of the user.

The detection of user-active events should take into consideration the lag time in between detectable events. However, during any periods when a threshold in lag time indicating a lack of attention is exceeded, interaction strength would be measured with reference to presentation channel characteristics and the manner in which the information item is situated within that channel, instead of with reference to actual user interaction. The lag time threshold can be established in various ways. For example, in the case of the typing example, the lag time threshold could either be a fixed amount of delay between keystrokes based on average users, or calibrated through apparatus or software applications to be more user-specific.

The attention that a user gives to an information item can also be measured through other kinds of attention tracking devices, ranging, without limitation, from other human observes to equipment such as eye motion tracking devices, etc.

When measuring activation based on user interactions with presented information item(s), it is also necessary to detect deliberate user absence. This condition can be measured via attention monitoring devices or through the detection of the absence of any user activities over a preset time threshold, as well as through the detection of system events such as screen saver activation within a computer.

The examples given herein are merely illustrative and the techniques employed to measure attention strength and compute base activation based on presentation and user attention/interaction will vary from situation to situation, as will the types of presentation channels, information items and systems to which the techniques may be applied by a person of ordinary skill in the art.

As previously indicated, base activation parameters can be developed and updated for information items. This is true regardless of the location or nature of the information items. For example, in a preferred embodiment involving computer networking, remote information items (e.g., on the Internet) can be treated in the same manner as local information items for the purpose of attaching base activation scores to the items and all such available items taken together can be considered a collective memory that is hereinafter called declarative memory. Thus, for example, browser-based information items, such as web pages, once visited, can be treated as local information items and activation scores can be attached to them. Therefore, visited Internet documents can become acquired information items and treated as retained information items similar to other local or personal information items.

As discussed, the base activation of a presented information item is measured in periods between detected events. The calculation and processing steps are iterated throughout the duration of the use of the information item, updating the set of parameters reflecting the base activation of the item. The most recently updated set of parameters is then stored when the item is closed.

Over time, the highly activated information items resulting from the practice of information items by a user would form a collection of information items that can be analyzed to enable categorization, or to provide a generalized context. Such categorization or context represent aspects of a user profile, and can be used as part of subsequent retrieval specifications to provide effective context relevant information retrieval.

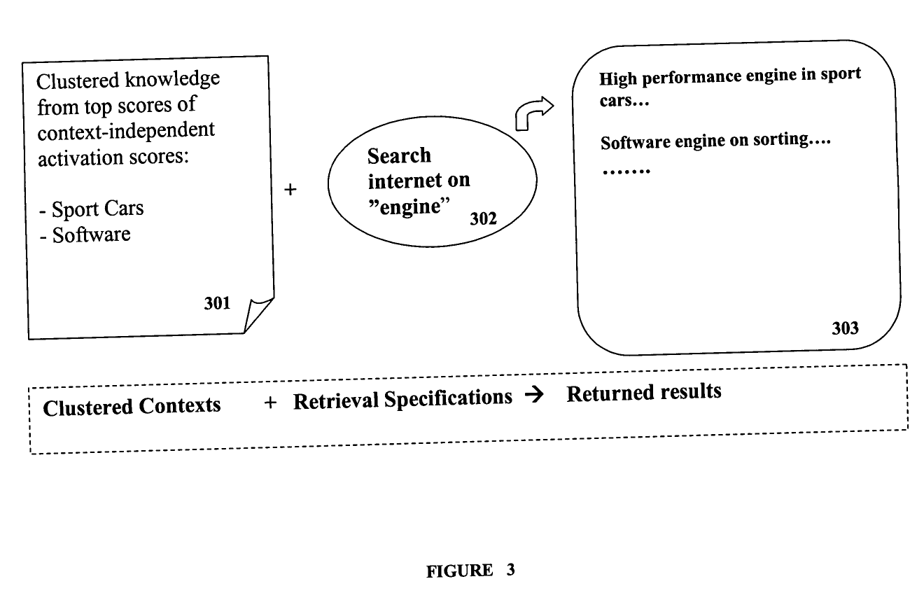

FIG. 3 illustrates an example with a user being a software developer (not shown), with a hobby in sports cars. Over time, the high base activation score information items within the user's personal computer can be analyzed to produce clustered information categories such as of “software” and “sports cars” 301. When a retrieval specification such as the word “engine” is used to search for information on the Internet 302, the query specification could be refined by applying the clustered information as a context boundary to produce relevant results such as “high performance engine in sports cars” or “software engine on sorting” 303.

It should be readily seen that the above-mentioned user-specific context definition can also be achieved through different combinations of high base activation score information items and retrieval specifications. For example, if the retrieval specification is “blue jays” and the user has spent a lot of time visiting baseball sites in the past, the combination of the retrieval specification and the context analysis derived from the high ranking of the items having high base activation scores will likely retrieve information on the Toronto Blue Jays baseball team, rather than on birds. Furthermore, a set of retrieved information items with base activation scores over a given threshold can in turn subsequently serve as a context for more specific retrieval of information items. The use of context analysis based on base activation is only an option; it can be turned on or off according to the user's retrieval goals.

Besides base level activation, the relevance of an information item also depends on associative activation from other items serving a similar goal, and the degree of (e.g., partial) matching in context between the information items. As in ACT-R, when two information items frequently appear together (i.e., co-occur) within a context, it is likely that the items are linked by a similar concept and will likely be deployed concurrently towards a goal.

The method of measuring the co-occurrence strength used employed as one method of deriving co-occurrence statistics is now disclosed. In order to derive co-occurrence statistics for information items in an information space, each period during which user attention (i.e., interaction) is directed at each item in the information space must be recorded (and each such period is hereinafter called an attention period). As previously noted, interaction time with an information item can be increased by any applicable attention inertia lead time when attention is directed towards an item before it is detected, and can be increased by any applicable attention inertia lag time when attention continues to be directed towards an item immediately after such attention is no longer detected. Such lead and lag times can be determined according to pre-defined specifications or according to probabilities based on typical human or individual behaviour. However, co-occurrence lead and lag times do not just have to model attention inertia; they can also be set according to pre-defined specifications in order to establish relevant co-occurrence periods in information management, for example, as part of a retrieval specification for information items.

The attention strength, measured in attention units, of each item for a given attention period (hereinafter called the attention period attention strength) is ascertainable according to the method for measuring attention strength disclosed above in connection with the computation of base activation. For each information item it is further assumed that the attention period attention strength corresponding to a given attention period is distributed evenly over the attention period, unless attention units are actually measured with the aid of attention-tracking devices, ranging, without limitation, from other human observes to equipment such as eye motion tracking devices, etc.

In order to account for the fact that information items are forgotten with the passage of time, a decay factor is applied to every attention period attention strength of an item. The result of that calculation corresponds to a “decayed value” of the said item's attention period attention strength for the particular attention period (and is hereinafter called decayed attention period attention strength).

One possible formula for computing decayed attention period attention strength (which is also expressed in attention units) is:
sᵢⱼ(t)=Sᵢⱼtⱼ^{-d}
where:
i is an information item
j is an interaction with document i corresponding to an attention period
t is the time in respect of which the decayed attention period attention strength is computed
sᵢⱼ (t) is the decayed attention period attention strength at a time t
Sᵢⱼ is the attention period attention strength of the j^{th} interaction with information item i
   tᵢⱼ is the time elapsed since end of j^{th} interaction with information item i and
   d is the decay factor.

For each item in the information space, the process described above is repeated for all past interactions with the item. Whenever a decayed attention period attention strength for an item is below a specified threshold (hereinafter called the memory threshold), the corresponding interaction with the item is considered forgotten. In that case, no corresponding co-occurrence calculation will be performed for that item with respect to that interaction.

If the decayed attention period attention strength for each of two items in respect of which co-occurrence is explored is not below the memory threshold, one item (hereinafter called the co-occurring item) will be said to co-occur with another item (hereinafter called the reference item) during any overlap in the corresponding attention periods of the co-occurring item and the reference item (and the duration of each such overlap is hereinafter called an overlap period).

A decayed attention strength attributable to the overlap period for the reference item (hereinafter called the reference item's decayed overlap attention strength) can then be computed as the quotient obtained by dividing the product of the overlap period and the reference item's decayed attention period attention strength by the reference item's attention period. If the reference item's decayed overlap attention strength is below a specified threshold (hereinafter called the co-occurrence threshold), the fact of the co-occurrence is considered forgotten and no co-occurrence strength is recorded for the co-occurring item for that overlap period with that reference item.

If the reference item's decayed overlap attention strength is not below the co-occurrence threshold, the co-occurrence strength of the co-occurring item is computed as the quotient obtained by dividing the product of the overlap period and the co-occurring item's decayed attention period attention strength by the co-occurring item's attention period. Such co-occurrence strength measurements are expressed in attention units and constitute statistical observation counts. Matrices of these counts can be processed using standard statistical techniques well known to those skilled in the art, to compute conditional probabilities that are further used to compute the odds of co-occurrence for the purpose of determining the associative activation of information item pairs in the information space, according to the well known ACT-R formula.

As just noted, for practicality of implementation, the present invention constructs matrices of conditional probabilities of information items from statistical counts of co-occurrence strength measurements. First, the counts are processed using probability calculations such as maximum likelihood estimation or expected likelihood estimation (i.e., Jeffrey-Perks Law) to derive conditional probabilities. The odds of co-occurrence between any two information items provides a direct measurement of the associative strengths of the said items, which is formulated as

$$ln \frac{P ( i \vert j )}{P ( \overline{i} \vert j )}$$

where P(i|j)is the probability of item i being present when item j is present, and P(i|j)is the probability of any item other than i being present when item j is present.

The similarity of two information items in a particular context basically corresponds to the similarity or dissimilarity in the probability distribution of the occurrence of the said items within a given information item space, and can be measured with standard methods such as Kullback-Leibler divergence and information radius calculations, well known to those skilled in the art. In other words, the probability distribution of the co-occurrence statistics encodes within itself contextual cues which provide a mechanism to measure the similarity of context associated with the occurrence of the information items in a defined information space. This is similar for information management purposes as what often occurs in human memorization, wherein the context of associated memory cannot be clearly defined, however, information items are still related through their representation of either similar concepts or cues.

Thus, the co-occurrence statistics can be used to compute conditional probabilities that are then employed to yield associative activation scores, while the similarity in probability distributions of the occurrence of items can be used to derive partial matching scores. While the preceding description focused on the measurement of co-occurrence strength values, other methods known to those skilled in the art can be used to derive the subsequent co-occurrence statistics.

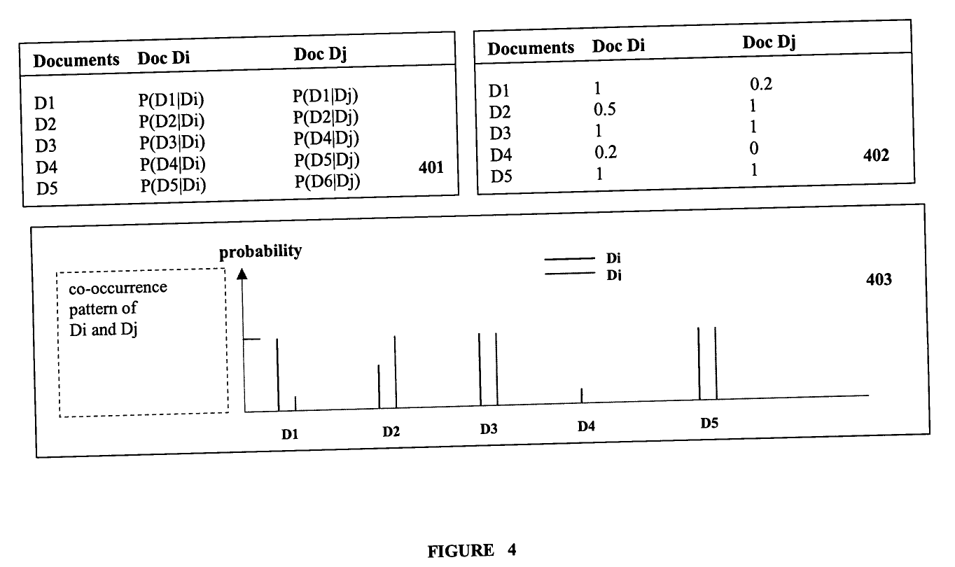

The following example demonstrates how the present invention provides a means to measure the similarity of probability distribution of occurrences among information items within an information space. With reference to FIG. 4, assume that an information space contains five information items (in this case documents) The first table 401 in FIG. 4 illustrates the symbolic representation of the probability of co-occurrence of each of two other documents Dᵢ and Dⱼ across the document space of D1 to D5. Over time, the probability of co-occurrences of Dᵢ and Dⱼ with each document D1 to D5 is calculated and the resulting probabilities are shown in table 402. The similarity in distribution of Dᵢ and Dⱼ given any one of the documents D1 to D5 in the information space can be represented graphically in graph 403. In this example, given D3 or D5 as an element of a goal, the probability of Dᵢ and Dⱼ serving that goal is 100%. In other cases, the probability is lower. It should be noted that in this example, the context of co-occurrence for Dᵢ and Dⱼ is the document space defined by D1 to D5. In this way, the degree to which Dᵢ or Dⱼ matches a goal that contains one of documents D1 to D5 can be determined. This is a special case of partial matching based on the probability distributions associated with the co-occurrence of information items. In other words the probability distributions of the occurrences of the two items Dᵢ and Dⱼ encode within themselves cues reflecting the degree of similarity in the context of the two items Dᵢ and Dⱼ.

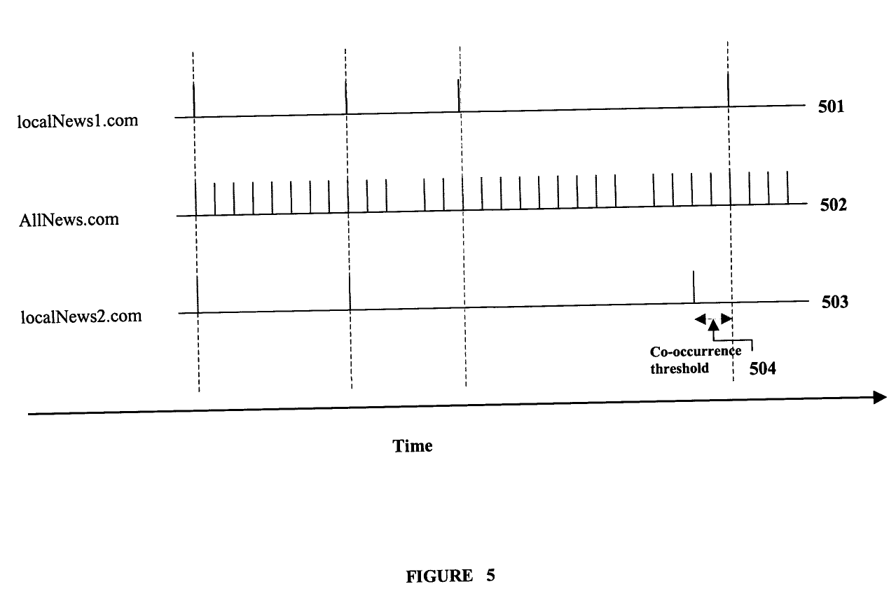

FIG. 5 shows an example of using co-occurrence probabilities in ranking information items within a time domain context. The goal is to locate websites that contain local news. For the purpose of the example, it is assumed that there are three such sources, localNews1.com 501, AllNews.com 502, localNews2.com 503, each having the same base activation score. If localNews1.com is already retrieved as an element towards the goal, it is necessary to determine whether either of AllNews.com or localNews2.com is also likely to be activated as solution to the goal. Based on ACT-R, the associative activation of an item i to a source j is measured by the expression WⱼSᵢⱼ, where Wⱼ is a weighting factor and Sᵢⱼ is the strength of association between item i and source j. In FIG. 5, AllNews.com 502 has four co-occurrences with localNews1.com 501, while localNews2.com 503 has three such co-occurrences. Therefore, AllNews.com 502 will score higher than localNews2.com 503 when associative strengths are measured. However, based on a partial matching measurement of similarity in contextual cues (i.e., based on the probability of distribution of the presence of the information items with respect to time), localNews2.com will score much higher due to its similarity in distribution with localNews1.com. The co-occurrence threshold 504 indicates the time of occurrence of information items need not be exactly identical in order for the items to be co-occurring; the occurrences only need to be situated within a certain proximity threshold.

The following example involving a time context further illustrates the benefits provided by the use of co-occurrence statistics within present invention. Consider a scenario where a user, Tom, who works with a large amount of information. The user has acquired a large number of documents and Internet links within his computer related to stocks, which is his area of interest. The user needs to retrieve one of these documents and a particular web link that the user remembers reviewing and visiting while reading an email sent from BigBank.com on Nov. 7, 2004, but the user does not remember the specific contents and location of the documents or the web page. Therefore, the user cannot search for them using keywords or by any other direct means in order to retrieve the items.

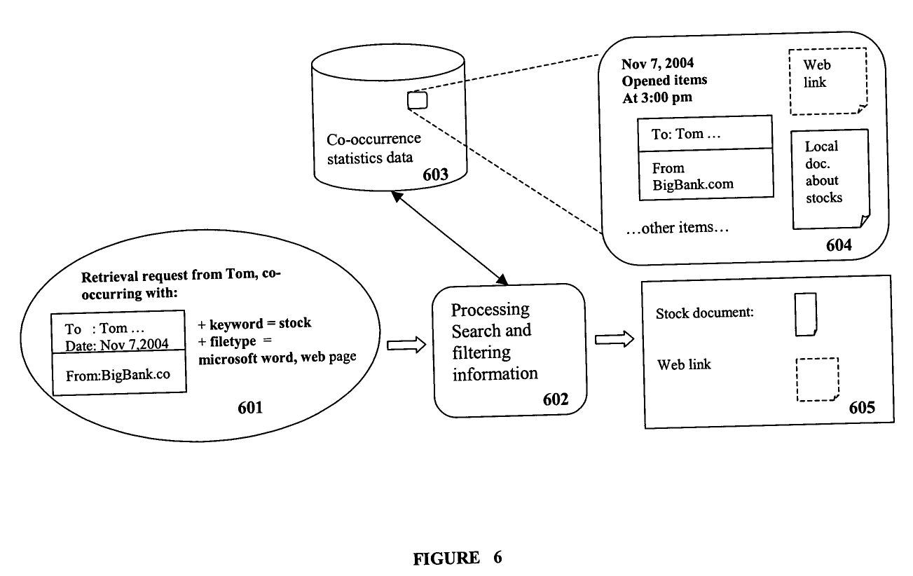

FIG. 6 illustrates how the present invention delivers the requested information. The retrieval specification 601 contains a co-occurrence request containing the email item from BigBank.com on Nov. 7, 2004, as well as specifying the keyword “stock” and certain filetypes. The processing module 602 requests co-occurrence information from the statistics database 603. The database 603 locates co-occurring information items related to the email from BigBank.com of Nov. 7, 2004 604, ranking them by base activation, and returns the information to the processing module 602. The processing module 602 then filters the items with keyword and filetype specifications, and delivers the precise results 605.

It can be readily seen in the aforementioned example, that the date and time factors do not form part of the retrieval specification. Since Tom spent quite some time reading the document and web page while the email item was opened, he can search on email items from BigBank.com with high base activation in combination with the co-occurrence statistics to achieve similar results.

Although the time domain is an obvious candidate for measuring co-occurrence probabilities of information items, co-occurrence statistics of information items can also be measured for an information space defined using attributes other than time. As an illustration, consider the email address “Tom@blah.com” as an element of an information space of interest. Email items to and from, cc, or bcc to “Tom@blah.com”, documents mentioning “Tom@blah.com” in the author metadata or content etc. are all “co-occurrences” within the context represented by “Tom@blah.com”. In other words, any type of existing relationship among items can form the basis for co-occurrence statistics. Therefore present invention provides a way to explore context of information items through co-occurrence statistics without the need to know or articulate the said relationships or context.

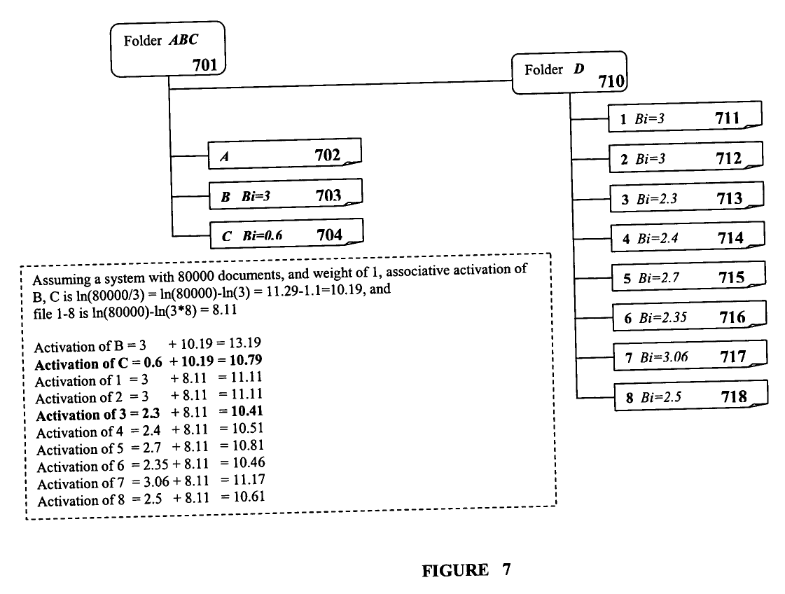

FIG. 7 illustrates the use of co-occurrence probabilities in measuring the associative strength of information items within a context other than time. Consider a case in which a user has a goal to backup files within folder ABC 701, and the user specifies file A 702 as a mandatory goal (i.e., the file must be backed up), and desires all other files ranked within the top 80% in terms of activation scores to be backed up as well. Since there is no other specification to measure partial matching, the only factor used to determine whether a file will be backed up is its activation score computed as the sum of its base level activation and associative activation. The probability of files B 703 and C 704 and folder D 710 co-occurring with file A 702 is ⅓ in the context of folder ABC 701, and that of each of the files 1-8 711-718 inside folder D 710 is ⅓*⅛. As aforementioned, the associative strength of an item i with activation source item j as an element of a goal, is a conditional probability computed as a logarithmic function of the probability of item i being needed when item j is present, divided by the probability of item j present without item i. In this illustration, assuming a system with 80,000 documents, the probability of file A 702 being present without the co-occurrence of other items is 1/80000, and hence the associative strengths of each of files B703 or C704 or folder D710 is In(80000/3), and the associative strength of each of the files 1-8 711-718 is In(80000/24). Whether a file passes the 80% activation criterion for back-up will then be dependent upon the sum of base activation score and the associative activation score of each file. Therefore in this illustration, file C704 and file 3 713 will not be backed up since their computed activation scores fall below the 20th percentile. Note that within the aforementioned example a weight of 1 was used for the purpose of computing associative activation, however, the said weight could be adjusted according to the importance of associative activation to the user in overall activation calculation.

It should also be noted that the illustration presented in FIG. 6 within the time domain involves probability calculations from observations, while the illustration presented in FIG. 7 involves probability calculations based on the number of outcomes. The present invention can merge outcome-based statistics with observation statistics (which may be co-occurrence strength values derived in accordance with the description set out above or other statistics measured in accordance with well known techniques) through statistical methods such as Expected Likelihood Estimation (Jeffrey-Perks Law) or Bayesian updating of probabilities, to name a couple.

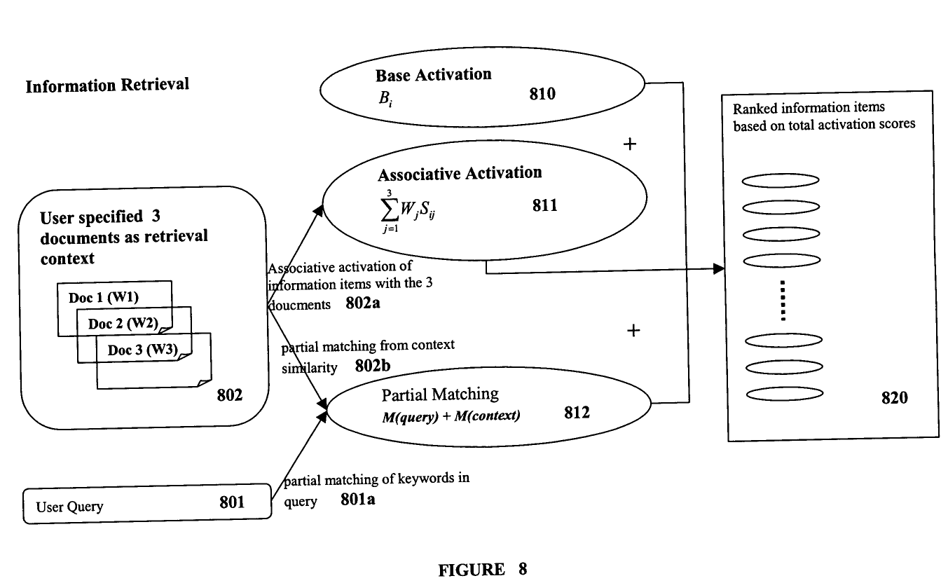

FIG. 8 illustrates the application of the present invention as a search system implemented in a preferred embodiment. A user (not shown) specifies an information retrieval query 801, as well as specifying the three documents 802, each with different weights W1, W2, and W3, representing relevance of each to the information item retrieval and ranking goal. The information items retrieved 820 are ranked according to their total activation scores, which for each item is the sum of its base activation 810, the associative activation scores 811 of the item with each of the three documents 802a, and partial matching scores 812 which includes the similarity in context of the item with each of the three documents 802b, as well as keyword matching with the user query 801a. Therefore the specification of the three documents 802 contributes to the computation of both associative activation 802a and partial matching 802b scores. In the aforementioned illustration, the user not only specifies the query, but is able to define a context with the three documents, which may or may not be describable, similar to human recall of memory in association with a context that may not be well defined. The aforementioned illustration also demonstrates the retrieval of items based on their past usefulness (base activation), associative strength with each of the three documents 802 (associative activation), and scores from matching user query and context similarity with the three documents 802 (partial matching). Since the present invention measures associative activation and context similarity based on co-occurrence statistics, it is agnostic to what the context actually is. Therefore the specification of any kind of context is possible. For example, a user can specify, without limitation, such contexts as an email item, the top most activated web links within a local web cache above a certain threshold, or currently opened documents within the presentation channel, to name a few.

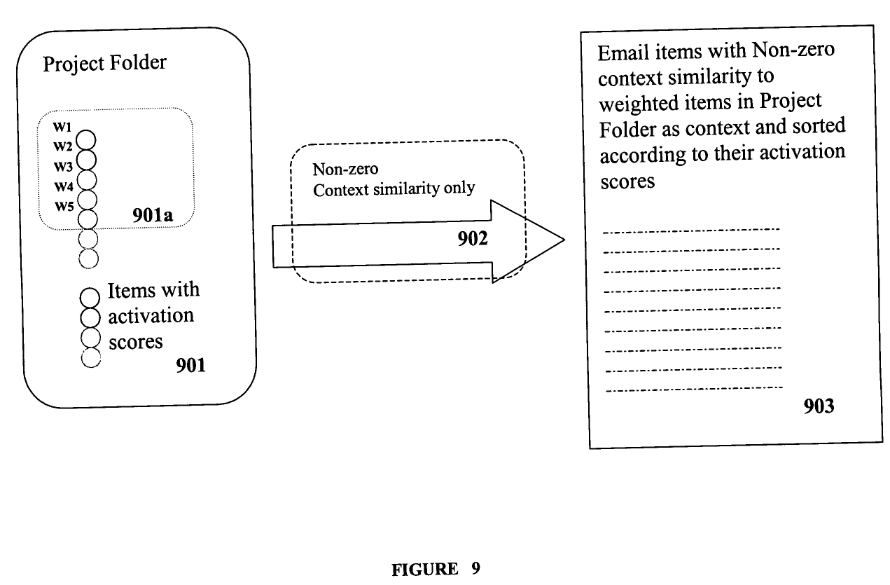

FIG. 9 illustrates a special filtering, sorting and display of email items that can only be achieved through the measurement of context similarity. Consider a project folder 901 which consists of thousands of items from projects over the years. The goal is to locate all email items that are related to a few frequently used project files within the folder 901. The inbox of emails could also contain thousands of items. As an example, the user could first select some (in this example five) of the top most activated items 901a within the project folder, assign them weights proportional to their activation scores, and then retrieve only email items 903 with non-zero partial matching context similarity 902 to the set of files 901a, and sort these email items 903 according to their activation scores.

The calculation of activation scores can also be applied to digital storage, so that information items (which can be private, publicly accessible, such as without limitation on the Internet, or some combination thereof) can be ranked and stored or deleted according to specified activation ranges or stored in different media in a cost-effective way. For example, information items contained in a knowledge base could be stored according to their activation scores. In such a case, information items can be stored on different media types, depending on the specified ranges of activation scores within which the activation scores of the information items fall. For example, those items having activation scores that fall in the higher ranges could be stored on fast retrievable media, and the information items with activation scores falling in lower percentiles could be stored on media (which can be private, publicly accessible, such as without limitation on the Internet, or some combination thereof) that are less frequently used or have lower access speeds. Similar decisions, based on ranges of activation scores of information items could be used to decide whether to store or delete information items, as well.

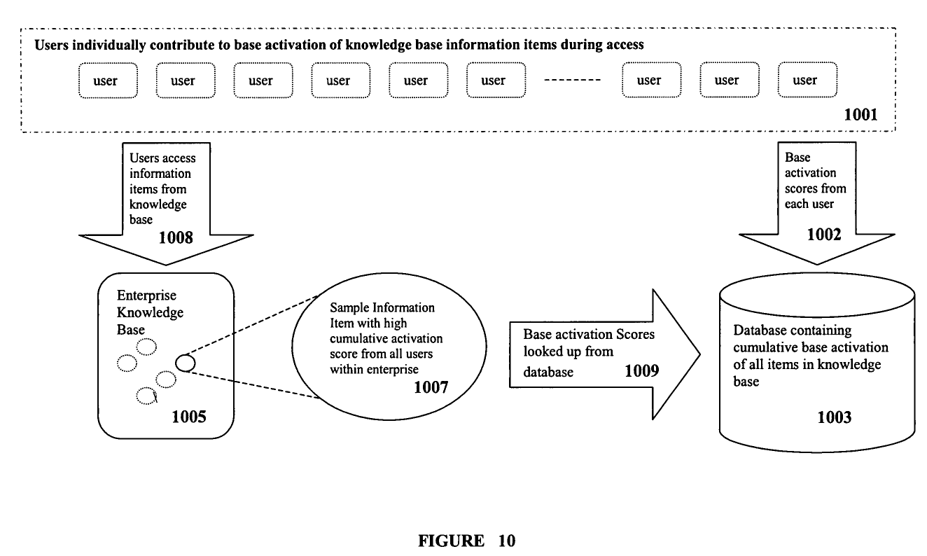

The prior art relies on the number of previous hits to rank information items within a knowledge base, but this ranking approach may not truly represent the relative usefulness of such items. FIG. 10 illustrates how the present invention can be used to deliver highly useful information items to enterprise users. All users 1001 within the enterprise (not shown) access information items in the enterprise knowledge base 1005 to facilitate their work. In the course of accessing 1008 and using such items, the base activation contributed to each item by each user is tracked and stored 1002 in a base activation database 1003. When a user wishes to retrieve items relating to a specified topic or category of knowledge (not shown), the knowledge base looks up 1009 the total base activation scores of the items contributed by all users 1001 in the enterprise from the database 1003. The high scores items 1007, which are proven more useful based on their base activation scores, will be ranked the highest and presented first to the user. It should be noted that an enterprise could be defined to be a single computer, the World Wide Web, or any combination of networked private and public information spaces containing information items whose base activation scores and co-occurrences statistics are tracked and stored.

The present invention can also be applied to presentation of information items within an information system, such as a computer system. The conventional graphic menus of operating systems sort menu items by category or by the alphabetical order of item names. Through the application of the present invention such sorting could instead be based on the past usefulness of items.

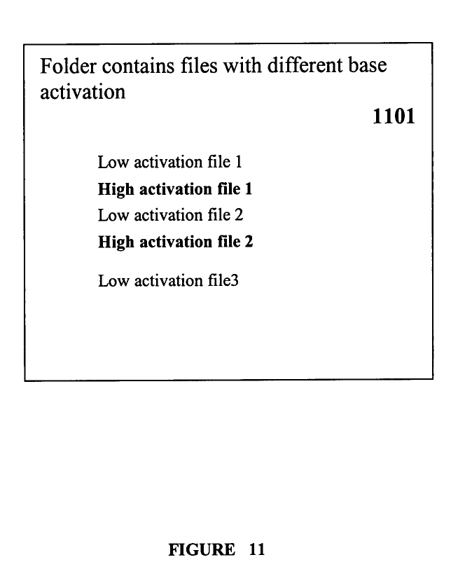

The application of base activation scores need not be limited to documents, but can also be applied to metadata and presentation attributes for accessibility. FIG. 11 illustrates a simple display where high base activation score items are displayed in bold face 1101. Similarly, other different visually perceptible distinguishing display features, such as different colors, contrast, font size or type, italicizing, etc., could also be used to reflect ranges of base activation scores of items.

The tracking of base activation can also be deployed in complex software applications which contains collaborative agents that assist users in achieving a goal, and conventionally use multiple presented choices and monitored user actions with presented data in order to guess a user's goal. Through base activation measurements, the user goal can be identified more precisely based on past use.

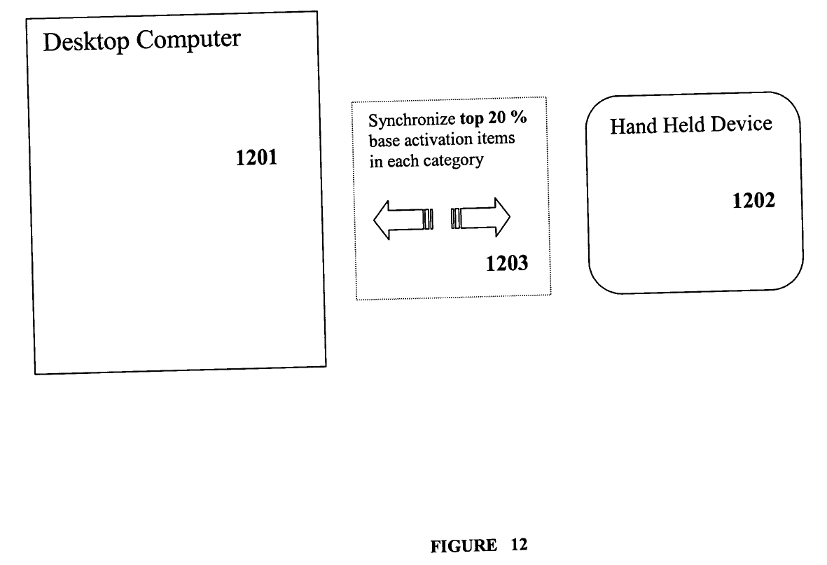

The present invention can also be applied as a data transmission filter. FIG. 12 illustrates a simple example of data transmission, the synchronization of data between a desktop computer 1201 and a personal digital assistant (PDA) or hand held device 1202. The hand held device 1202 has limited storage space and communication bandwidth. Typically, a user (not shown) chooses categories, such as emails, a calendar, and/or file folders located on the desktop computer 1201 for synchronization. However, the said categories and file folders often contain information items in excess of the number of information items that the user desires to transfer to the PDA through synchronization, or that the PDA can accommodate. With the implementation of present invention, users can choose to synchronize only information items with high percentiles of base activation scores 1203. In the said illustration, base activation scores can, if desired, be combined with other specifications, such as categories or file folders, to specify filters applicable to other more complex transmission scenarios. In addition, this technique can be used by a person skilled in the art to synchronize data between two or more devices of various kinds capable of data transmission, where at least one of the devices contains information items having base activations scores.

Combining base activation, associative activation/partial matching (as represented by co-occurrence statistics) measurement in information management constitutes a new area in information management. Using an approach that relies on one or more of these factors can yield a much higher degree of relevance and usefulness in the retrieval, ranking and/or other management of information items based on specific goals.

Thus, methods and systems for applying attention strength, activation scores and co-occurrence statistics to information management are disclosed. Though the present invention is described with respect to specific preferred embodiments described above, it would be apparent to those skilled in the art to apply the present invention in other information management contexts or systems.

What is claimed is:

1. A method for measuring the attention strength directed by a user towards one of one or more information items present in a presentation channel during an interaction period in which the user directs attention towards a target information item through one or more proactive or passive interactions with the target information item, said method comprising:
(a) recording the start time of the interaction period as represented by the start of an event through which the user directs attention towards the target information item,
(b) recording the end time of the interaction period as represented by one of:
(i) the passage of a specified period of time during which the user does not direct any attention towards the target information item, or
(ii) the start of another event that confirms that the user is not directing any attention towards the target information item,
(c) measuring the duration of the interaction period as the difference between the end time and the start time of the interaction period,
(d) dividing the duration of the interaction period into attention units appropriate to the presentation channel,
(e) counting the number of attention units within the interaction period during which the user directed attention towards the information item proactively (hereinafter called the proactive attention period),
(f) counting the number of attention units within the interaction period during which the user directed attention towards the information passively (hereinafter called the passive attention period),
(g) allocating the attention units described in (e) to the target information item, and
(h) allocating the attention units described in (f) among the target information item and all of the rest of the information items present in the presentation channel, based on the presentation characteristics of each of the information items in the presentation channel.

2. The method of claim 1, wherein the presentation channel is visual and the attention unit is one of:
(a) in the range of 200 to 400 milliseconds, and
(b) determined by eye-tracking devices.

3. The method of claim 1, wherein the presentation channel is auditory and the attention unit is an integer multiple of the smallest note length perceptible by humans.

4. The method of claim 1, wherein the specified period of time in claim 1(b)(i) is determined with reference to at least one of:
(a) the probability distribution(s) of the duration of events involving the direction of attention by humans towards information items in the presentation channel,
(b) the probability distribution(s) of the duration of events involving the direction of attention by the user towards information items in the presentation channel, and
(c) measured directly using attention-tracking devices.

5. The method of claim 1, wherein the presentation characteristics in claim 1 (h) include at least one of: relative size, color contrast, animation, rate of change of presentation, static and dynamic graphical elements, distance from the identified information item of most recent focus, font sizes of the information items, the amount of real estate occupied by information items within the presentation channel, the amount of time elapsed since the previous focused user activity, and the distance of the target information item from the previous item that enjoyed full user attention.

6. The method of claim 1, wherein the presentation characteristics in claim 1 include at least one of: relative rate of change of presentation, presence or addition of sound, static and dynamic audio elements, the amount of real estate occupied by information items within the presentation channel, the amount of time elapsed since the previous focused user activity, and the volume, frequency, loudness, or pitch of any audio signals present in the presentation channel.

7. A method of measuring co-occurrence of attention strength (hereinafter called co-occurrence strength) between pairs of co-information items in an information space, said method comprising:
(a) for each information item in the information space for which it is desired to derive one or more co-occurrence strength values (each such item hereinafter called a co-occurring item) with one or more other information items in the information space (each such other item hereinafter called a reference item) and for each reference item,
(i) for each of the periods during which user attention also known as an interaction is directed at the said information item (hereinafter called the attention period),
(A) recording when the attention period occurs and its duration,
(B) measuring the attention period strength of the item during the attention period in (A),
(C) applying a decay factor to the attention period attention strength in (B) that that takes into account any decay in memory of the attention period attention strength, thereby yielding a corresponding decayed attention period attention strength,
(D) for each occurrence of an overlap in attention periods of a pair of co-occurring item and reference items (each such overlap hereinafter called an overlap period), comparing the decayed attention period attention strength of each of the items from (C) with a specified threshold value (hereinafter called the memory threshold),
(E) where the corresponding decayed attention period attention strength in (C) for each item in the pair of co-occurring item and reference items in (D) is greater than the memory threshold in (D), computing, for the reference item, a decayed attention strength attributable to a corresponding overlap period in
(F) (hereinafter called the reference item's decayed overlap attention strength), computed as the quotient obtained by dividing the product of the overlap period and the reference item's corresponding decayed attention period attention strength by the reference item's corresponding attention period, and
(G) where the reference item's decayed overlap attention strength in (F) is above a specified threshold (hereinafter called a co-occurrence threshold), the co-occurrence strength of the co-occurring item is computed as the quotient obtained by dividing the product of the overlap period in (F) and the co-occurring item's corresponding decayed attention period attention strength by the co-occurring item's corresponding attention period.

8. A method for deriving activation scores of an information item, said score comprising the sum of the information item's base activation, associative activation and/or partial matching score, said method comprising: deriving the base activation score of the information item based on attention strength measurements, and deriving the associative activation and partial matching scores of the items based on co-occurrence strength measurements made according to claim 7.

9. A method according to claim 7 for ranking information items retrieved in response to a search query according to scores comprising one or more of the following:
(a) computing cumulative base activation scores of the information items, where for the purpose of computing said base activation scores, attention strength is measured,
(b) computing associative activation scores of the information items using co-occurrence strengths in respect of the information items measured, and
(c) partially matching scores based on the similarity of probability distributions of the occurrences of the information items using co-occurrence strengths in respect of the information items measured or other co-occurrence statistics.

10. A method for selecting which of various information items having activation scores derived in accordance with claim 8 in a knowledge base will be stored based on the activation scores of the said items, said method comprising: storing only those items having activation scores within certain prescribed ranges.

11. A method for selecting which of various information items having activation scores derived in accordance with claim 8 in a knowledge base will be deleted based on the activation scores of the said items, said method comprising: deleting only those items having activation scores within certain prescribed ranges.

12. A method for selecting which of various information items having activation scores derived in accordance with claim 8 in a knowledge base will be stored on which of a plurality of storage media categories based on the activation scores of the said items, said method comprising:
(a) defining the storage media categories based on ranges of activation scores, and
(b) choosing the storage medium on which a given information item will be stored based on it's activation score, such that it is stored on one or more storage media of a category associated with the range of activation scores that encompasses the activation score of the information item.

13. The method according to claim 10, wherein the knowledge base includes information items located within private and/or publicly available information spaces, including the Internet.

14. The method according to claim 10, wherein the storage media are private and/or publicly available, including on the Internet.

15. The method according to claim 12, wherein the storage media are categorized by access speed and information items with activation scores falling in higher activation score ranges are stored on media having faster access speeds than information items with activation scores falling in lower activation score ranges.

16. A method for displaying information items ranked according to their activation scores in accordance with claim 9, comprising:
distinguishing the display of information items having activation scores within various ranges of such scores by having each such range associated with a visually perceptible distinguishing display feature.

17. A method for synchronizing information items stored on a plurality of devices capable of data transmission, wherein at least one information item stored in at least one of the device has a base activation score computed in accordance with claim 8, said method comprising:
synchronizing only those information items whose activation scores are above a certain threshold.

18. An information retrieval and ranking system comprising:
(a) means for launching, via a user interface, a query for information items according to specific search criteria selected by a user,
(b) means for retrieving all available information items that match the search criteria,
(c) means for ranking those retrieved information items for which base activation, associative activation and/or partial matching (hereinafter collectively called activation) scores,
(d) means for ranking those retrieved information items for which activation scores are not available according to user preferences, and
(e) means for displaying the search results according to the rank order of the information items.

19. The system of claim 18, wherein the specific search criteria selected by the user include a context defined by one or more specified information items.

20. The system of claim 10, wherein only those retrieved information items that have non-zero partial matching scores are displayed as search results and the said items are ranked according to their partial matching scores for the purpose of the said display.

21. The system of claim 18, wherein the available information items are located within private and/or publicly available information spaces, including the Internet.

22. The system of claim 18, wherein a user specific context for the ranking of retrieved information items is implicitly developed through the activation scores assigned to the said information items and the said user defined context becomes at least one search criterion for subsequent information item searches by requiring that, in the case of such subsequent searches, only information items having an activation rank above a certain pre-determined level be displayed following the retrieval and ranking of all available information items according to all applicable search an d ranking criteria.
